(19) United States
(12) Patent Application Publication
(10) Pub. No.: US 2015/0134405 A1
(43) Pub. Date: May 14, 2015

(54) PERSONAL SERVICE PROVIDING SYSTEM, INFORMATION COLLECTION AND ANALYSIS SERVER, AND METHODS THEREOF

(71) Applicant: Institute For Information Industry, Taipei (TW)

(72) Inventors: Yen-Hung KUO, Taipei City (TW); Yu-Lin JENG, Tainan City (TW); Jay UNGER, Darnestown, MD (US); Phoenix LEE, New Taipei City (TW)

(73) Assignee: Institute For Information Industry, Taipei (TW)

(21) Appl. No.: 14/079,608

(22) Filed: Nov. 13, 2013

(51) Int. Cl. G06Q 30/02; G06Q 20/20

(52) U.S. Cl. CPC G06Q 30/0201; G06Q 20/204
USPC 705/7.29

(57) ABSTRACT

A personal service providing system, an information collection and analysis server and the methods thereof are provided. The information collection and analysis server receives a record of a transaction from a service end, generates a distinct link associated with the record, and transmits the distinct link to the service end. The service end generates a machine-readable code by embedding the distinct link therein. A user device obtains the distinct link from the machine-readable code and transmits an identity to the information collection and analysis server through the distinct link. The information collection and analysis server receives the identity from the user device and associates the identity with the record according to the distinct link.

### FIELD

The present invention relates to a personal service providing system, an information collection and analysis server and the methods thereof. More particularly, the information collection and analysis server analyzes user behaviors by collecting records of transactions from service ends. Each collected record is associated with an identity of a user device that accesses the information collection and analysis server through a distinct link embedded in a machine-readable code.

### BACKGROUND

Due to the enormous development of telecommunication networks, people are able to obtain a variety of information from the Internet through a user device (e.g. smart phones, notebooks, personal computers etc.). To provide users with more information, service providers (e.g. retail stores, web stores, libraries, the banks, etc.) collect the users' behaviors by recording their web surfing, asking them to apply for membership cards, or asking for their feedback for rewards. However, the user behavior collected by the above approaches requires pre-registration and membership and may be from a specific scope or domain that is difficult to access. In view of this, it is important to provide a solution capable of accurately collecting user behaviors without pre-registered membership and domain boundary.

### SUMMARY

A primary objective of certain embodiments of the invention is to provide a collection mechanism to accurately collect user behaviors without pre-registered membership and domain boundary to provide users with the information they need based on the analysis of the collected user behaviors.

To achieve the aforesaid objective, certain embodiments of the present invention disclose a personal service providing system which comprises a service end and an information collection and analysis server. The service end generates a record of a transaction. The information collection and analysis server is connected to the service end via a network. The information collection and analysis server receives the record from the service end, stores the record, generates a distinct link associated with the record, and transmits the distinct link to the service end. The service end further generates a machine-readable code by embedding the distinct link therein so that when a user device obtains the distinct link from the machine-readable code, the user device transmits an identity to the information collection and analysis server through the distinct link. The information collection and analysis server further associates the identity with the record according to the distinct link.

In addition, certain embodiments of the present invention further disclose a method for use in a personal service providing system including a service end and an information collection and analysis server. The information collection and analysis server is connected to the service end via a network. The method comprises the following steps: (a) generating, by the service end, a record of a transaction; (b) transmitting, by the service end, the record to the information collection analysis server via a network; (c) receiving, by the information collection and analysis server, the record from the service end via the network; (d) storing, by the information collection and analysis server, the record; (e) generating, by the information collection and analysis server, a distinct link associated with the record, (f) transmitting, by the information collection and analysis server, the distinct link to the service end, (g) generating, by the service end, a machine-readable code by embedding the distinct link therein so that when a user device obtains the distinct link from the machine-readable code, the user device transmits an identity to the information collection and analysis server according to the distinct link; and (h) associating, by the information collection and analysis server, the identity with the record according to the distinct link.

To achieve the aforesaid objective, certain embodiments of the present invention further disclose an information collection and analysis server which comprises a network interface, a processor and a storage. The network interface is connected to a network. The processor is electrically connected to the network interface and the storage. The processor receives a record of a transaction from a service end via the network interface, generates a distinct link associated with the record, and transmits the distinct link to the service end via the network interface. The service end generates a machine-readable code by embedding the distinct link therein so that when a user device obtains the distinct link from the machine-readable code, the user device transmits an identity to the information collection and analysis server through the distinct link via the network. The processor further receives the identity from the user device via the network interface and associates the identity with the record according to the distinct link. The storage stores the record, the distinct link and the identity.

In addition, certain embodiments of the present invention further disclose a method for use in an information collection and analysis server comprising a network interface, a processor and a storage. The network interface connected to a network. The processor is electrically connected to the network interface and the storage. The method executed by the processor and comprising the following steps: (a) receiving a record of a transaction from a service end via the network interface; (b) storing the record in the storage; (c) generating a distinct link associated with the record; (d) transmitting the distinct link to the service end via the network interface, wherein the service end generates a machine-readable code by embedding the distinct link therein so that when a user device obtains the distinct link from the machine-readable code, the user device transmits an identity to the information collection and analysis server through the distinct link via the network; (e) receiving the identity from the user device via the network interface; and (f) associating the identity with the record according to the distinct link.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 depicts a schematic view of a personal service providing system of the present invention, which includes the information collection and analysis server 11 and the service end 31;

FIG. 2 depicts a schematic view of an example of the service end 31 of the present invention;

FIG. 3 depicts a schematic view of the information collection and analysis server 11 of the present invention.

FIG. 4 is a flowchart diagram of a method for use in a personal service providing system according to the third embodiment of the present invention; and

FIG. 5 is a flowchart diagram of a method for use in an information collection and analysis server according to the fourth embodiment of the present invention.

### DETAILED DESCRIPTION

In the following description, the present invention will be explained with reference to example embodiments thereof. However, these example embodiments are not intended to limit the present invention to any specific examples, embodiments, environment, applications or particular implementations described in these embodiments. Therefore, the description of these example embodiments is only for the purpose of illustration rather than limitation. In the following embodiments and attached drawings, elements not directly related to the present invention are omitted from depiction; and the dimensional relationships among individual elements in the attached drawings are illustrated only for ease of understanding, but not to limit the actual scale.

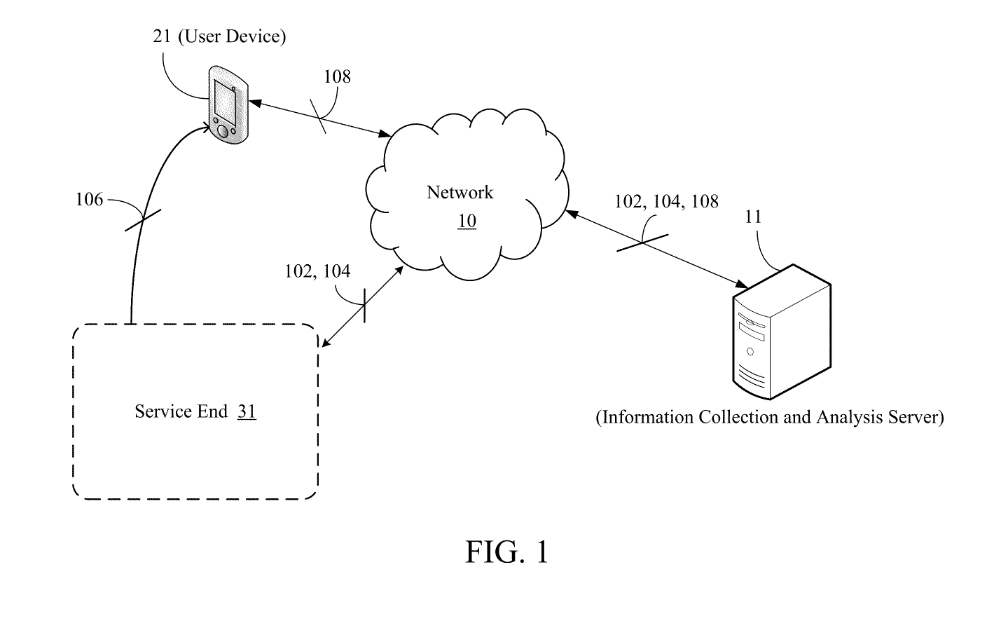

The first embodiment of the present invention is depicted in FIG. 1, which illustrates a personal service providing system including an information collection and analysis server 11 and a service end 31. The information collection and analysis server 11 and the service end 31 are connected to a network 10 to communicate with each other via the network 10. The network 10 is a telecommunications network including (but not limited to) computer networks, the Internet, the telephone network, etc.

The service end 31 is constituted by the devices of the service providers (e.g. retail stores, web stores, libraries, the banks, etc.). When a user completes a transaction with the service end 31, the service end 31 generates a record 102 of the transaction and transmits the record 102 to the information collection and analysis server 11 via the network 10. For example, the transaction may be buying goods from a retail store or a web store, borrowing books from a library. The record 102 is the information about the transaction (e.g. an ordered list or a borrowed list).

After receiving the record 102 from the service end 31 via the network 10, the information collection and analysis server 11 stores the record 102 and generates a distinct link 104 (e.g. https://url/xxx) associated with the record 102. It shall be stated that the information collection and analysis server 11 is usually connected to a plurality of the service ends which belong to different service providers and are also capable of generating a record of every completed transaction. Thus, the information collection and analysis server 11 will consequently receive records from the service ends (including the service end 31) and then generate a distinct link for each record. Furthermore, in this embodiment, each distinct link is unique to a record, e.g. the distinct link 104 is unique to the record 102.

Next, the information collection and analysis server 11 transmits the distinct link 104 to the service end 31. Once the distinct link 104 is received, the service end 31 generates a machine-readable code 106 by embedding the distinct link 104 therein. The machine-readable code 106 may be a 2D barcode (e.g. a QR code printed on a receipt) or a NFC signal written into a NFC tag. Thereafter, a user can get the machine-readable code 106 from the service end 31, perhaps from a paper receipt printed by the service end 31 or from an electronic receipt generated and delivered by the service end 31.

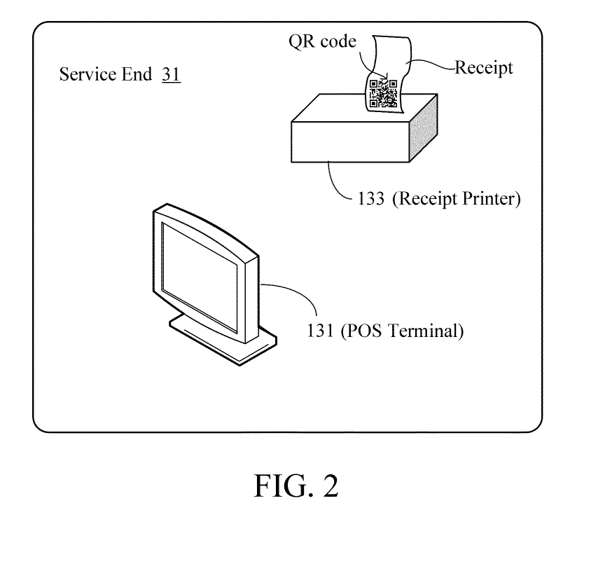

For example, as show in FIG. 2, the service end 31 comprises a Point of Sales (POS) terminal 131 and a receipt printer 133. The POS terminal 131 may be a computerized device for service staffs or users to complete transactions and may be further connected to a remote server. The POS terminal 131 is connected to the network to transmit the record 102 to the information collection and analysis server 11 and receives the distinct link 104 from the information collection and analysis server 11. The POS terminal 131 generates a QR code by embedding the distinct link 104 therein and enables the receipt printer 133 to print the QR code on a receipt. As a result, by scanning the QR code through the camera of the user device 21, the distinct link 104 would be obtained.

It should be noted that the service end 31 is not limited to the above example. In practice, the service end 31 may be only constituted by a stand-alone device or a remote server. When the service end 31 is a remote server, the service end 31 provides a web service (e.g. an on-line shopping site) for users to complete the transactions.

Afterwards, after obtaining the distinct link 104 from the machine-readable code 106, the user device 21 transmits an identity 108 (e.g. the cell phone number assigned to the user device 21 or an account of a mobile application installed in the user device 21) to the information collection and analysis server 11 through the distinct link 104 via the network 10. By retrieving the information through the distinct link 104, the information collection and analysis server 11 associates the identity 108 with the record 102.

It can be appreciated the information collection and analysis server 11 would store other records associated with the same identity 108 since the same user would complete several transactions with the service end 31 or other service ends which are also connected to the information collection and analysis server 11. In this case, because each of the other records is related to a transaction and associated with a distinct link, the information collection and analysis server 11 could analyze the record 102 and other records to provide service information related to the transactions to the user device 21 or to provide an analysis result to the service end 31 or other services ends.

Specifically, based on the items and other detailed information (e.g. times, locations, prices, categories, etc) of the transactions, the information collection and analysis server 11 could deduce the service information which the user of the user device 21 may need or interest (e.g. new products, new books, activity news, bargain news, etc.) and then provide the service information to the user, by sending a Short Message Service (SMS) message, a Multimedia Messaging Service (MMS) message or other instant message of a specific mobile application to the user device 21.

In addition, the information collection and analysis server 11 may provide an add-on service (e.g. automatically debiting the amount of user's purchase, checking the records, or obtaining rewards) when the user device 21 accesses the information collection and analysis server 11 through the distinct links (e.g. the distinct link 104). For example, by providing the rewards, it can increase users' incentive to obtain the distinct links embedded in machine-readable codes and access the information collection and analysis server 11 through the distinct links after every transaction completed. Besides, according to the analysis result provided by the information collection and analysis server 11, the service end 31 or other service end could also provide service information for users.

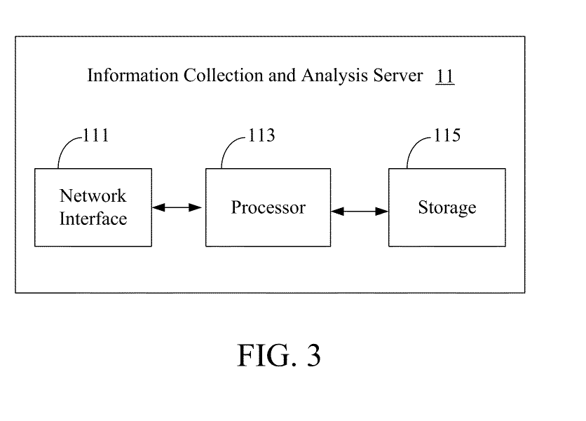

The second embodiment of the present invention is depicted in FIG. 3, which illustrates the information collection and analysis server 11. The information collection and analysis server 11 comprises a network interface 111, a processor 113 and a storage 115. The processor 113 is electrically connected to the network interface 111 and the storage 115. The network interface is connected to the network 10. The storage 115 may be a tangible machine-readable medium or a combination of multiple tangible machine-readable medium for providing the information collection and analysis server with a permanent storage, such as a flash memory, a hard disk, or any other storage media with the same function and well known to those skilled in the art.

The processor 113 is configured to receive the record 102 of the transaction from the service end 31 via the network interface 111 and generate the distinct link 104 associated with the record 102. The storage 115 stores the record 102 and the distinct link 104. Afterwards, the processor 113 transmits the distinct link 104 to the service end 31 via the network interface 111. As mentioned in the first embodiment, the service end 31 then generates the machine-readable code 106 by embedding the distinct link 104 therein so that when the user device 21 obtains the distinct link 104 from the machine-readable code 106, the user device 21 transmits the identity 108 to the information collection and analysis server 11 through the distinct link 104.

Next, the processor 113 receives the identity 108 from the user device 21 via the network interface 111 and associates the identity 108 with the record 102 according to the distinct link 104. The storage 115 further stores the identity 108. It is conceivable that the storage 115 also stores other records associated with the identity 108. Each of the other records related to a transaction and associated with a distinct link. Therefore, the processor 113 could analyze the record 102 and the other records to generate service information related to the transactions and transmit the service information to the user device 21 via the network interface 111 or to generate an analysis result and transmit the analysis result to the service end 31 via the network interface 111.

Furthermore, the processor 113 could generate add-on information when the user device 21 accesses the information collection and analysis server 11 through the distinct links (e.g. the distinct link 104), and then transmits the add-on information to the user device 21 via the network interface 111. The add-on information may be the amount of the user's purchase, one of the records which user wants to check, the amount of rewards or any information which benefits the user.

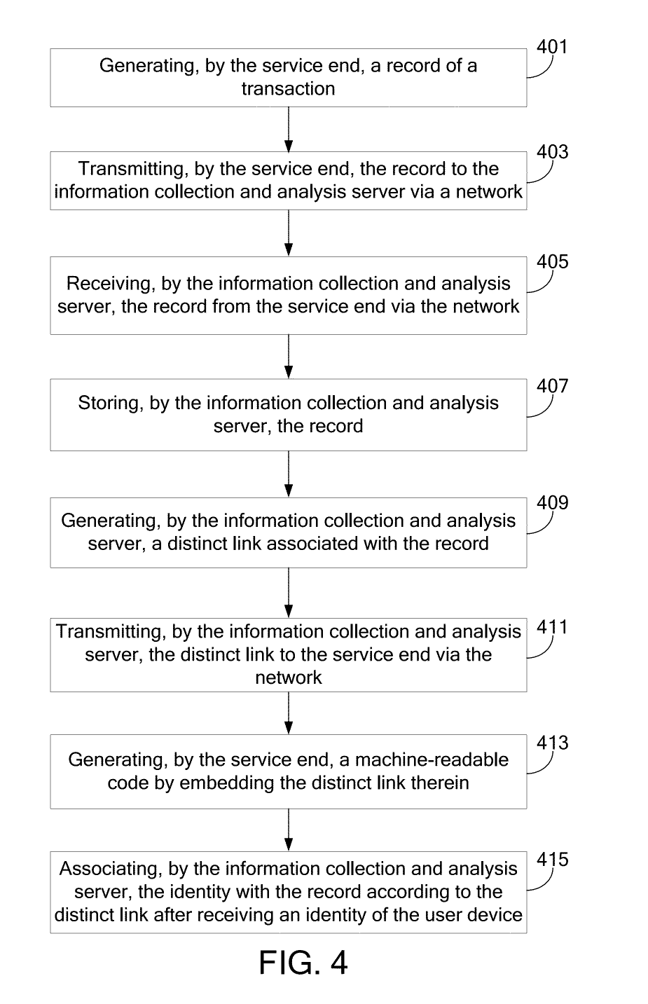

The third embodiment of the present invention is a method for use in a personal service providing system including an information collection and analysis server and a service end and a flowchart of which is illustrated in FIG. 4. The method of this embodiment can be adapted to the personal service providing system including the information collection and analysis server 11 and the service end 31 set forth in the first embodiment.

First, step 401 is executed to generate, by the service end, a record of a transaction. Step 403 is executed to transmit, by the service end, the record to the information collection analysis server via a network. Then, step 405 is executed to receive, by the information collection and analysis server, the record from the service end via the network. Step 407 is executed to store, by the information collection and analysis server, the record. Following that, step 409 is executed to generate, by the information collection and analysis server, a distinct link associated with the record.

Next, step 411 is executed to transmit, by the information collection and analysis server, the distinct link to the service end via the network. Subsequently, step 413 is executed to generate, by the service end, a machine-readable code by embedding the distinct link therein. Under this circumstance, when a user device obtains the distinct link from the machine-readable code, the user device transmits an identity to the information collection and analysis server through the distinct link via the network. Then, step 415 is executed to associate, by the information collection and analysis server, the identity with the record according to the distinct link.

In other embodiments, it is conceivable that the information collection and analysis server further stores other records associated with the identity and each of the other records related to a transaction and associated with a distinct link. Under this circumstance, the method for use in the personal service providing system of the present invention may execute another step (not shown) of analyzing, by the information collection and analysis server, the record and the other records to provide service information related to the transactions to the user device. In this case, the personal service providing system could have more commercial value by providing the service information to the user device.

In other embodiments, it is conceivable that the information collection and analysis server further stores other records associated with the identity and each of the other records related to a transaction and associated with a distinct link. Under this circumstance, the method for use in the personal service providing system of the present invention may execute another step (not shown) which is analyzing, by the information collection and analysis server, the record and the other records to provide an analysis result to the service end. In this case, the personal service providing system could have more commercial value by providing the analysis result to the service end.

Besides, in other embodiments, the method for use in the personal service providing system of the present invention may execute another step (not shown) which is providing, by the information collection and analysis server, an add-on service when the user device accesses the information collection and analysis server through the distinct link. In this case, the add-on service can increase users' incentive to obtain the distinct links embedded in machine-readable codes and access the information collection and analysis server through the distinct links after every transaction completed.

In addition to the aforesaid steps, the method of this embodiment can also execute all the operations and functions set forth in the first embodiment. The method in which the embodiment executes these operations and functions will be readily appreciated by those of ordinary skill in the art based on the explanation of the first embodiment, and thus, will not be further described herein.

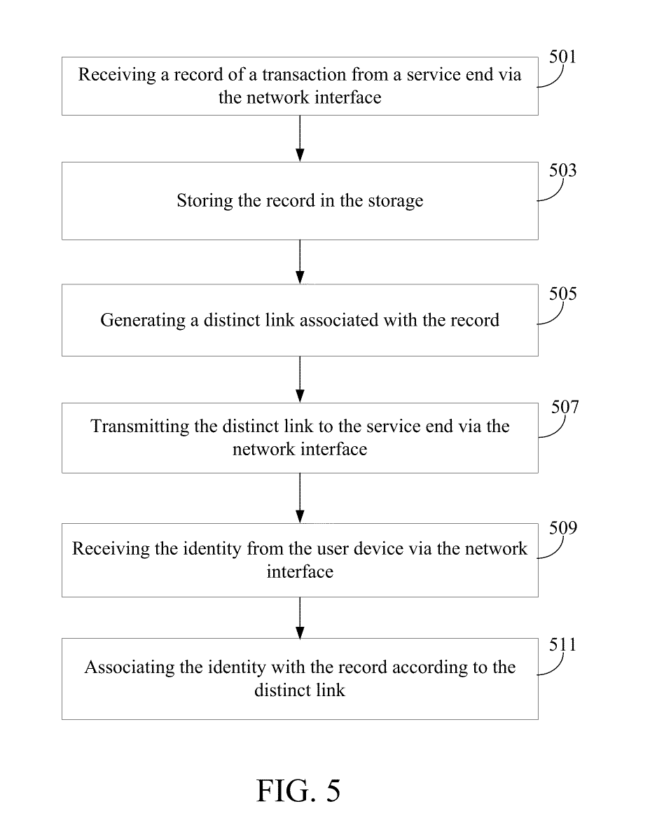

The fourth embodiment of the present invention is a method for use in an information collection and analysis server and a flowchart of which is illustrated in FIG. 5. The information collection and analysis server comprises a network interface, a processor and a storage. The network interface is connected to a network. The method of this embodiment can be adapted to the information collection and analysis server 11 set forth in the second embodiment. The method is executed by the processor.

First, step 501 is executed to receive a record of a transaction from a service end via the network interface. Step 503 is executed to store the record in the storage. Then, step 505 is executed to generate a distinct link associated with the record. Step 507 is executed to transmit the distinct link to the service end via the network interface. Later on, after receiving the distinct link from the information collection and analysis server, the service end generates a machine-readable code by embedding the distinct link therein.

Under this circumstance, when a user device obtains the distinct link from the machine-readable code, the user device transmits an identity to the information collection and analysis server through the distinct link via the network. Following, step 509 is executed to receive the identity from the user device via the network interface. Subsequently, step 511 is executed to associate the identity with the record according to the distinct link.

In other embodiments, it is conceivable that the storage further stores other records associated with the identity and each of the other records related to a transaction and associated with a distinct link. As a result, the method for use in an information collection and analysis server of the present invention may execute other steps (not shown) which includes the following steps: analyzing the record and the other records to generate service information related to the transactions; and transmitting the service information to the user device via the network interface. In this case, the information collection and analysis server of the present invention could have more commercial value by providing the service information to the user device.

In other embodiments, it is conceivable that the storage further stores other records associated with the identity and each of the other records related to a transaction and associated with a distinct link. As a result, the method for use in an information collection and analysis server of the present invention may execute other steps (not shown) which includes the following steps: analyzing the record and the other records to generate an analysis result; and transmitting the analysis result to the service end via the network interface. In this case, the information collection and analysis server of the present invention could have more commercial value by providing the analysis result to the service end.

Besides, in other embodiments, the method for use in the personal service providing system of the present invention may execute other steps (not shown) which include the following steps: generating add-on information when the user device accesses the information collection and analysis server through the distinct link; and transmitting the add-on information to the user device via the network interface. In this case, the add-on service can increase users' incentive to obtain the distinct links embedded in machine-readable codes and access the information collection and analysis server through the distinct links after every transaction is completed.

In addition to the aforesaid steps, the method of this embodiment can also execute all the operations and functions set forth in the second embodiment. The method in which the embodiment executes these operations and functions will be readily appreciated by those of ordinary skill in the art based on the explanation of the second embodiment, and thus, will not be further described herein.

According to the above descriptions, the present invention provides a collection mechanism which collects user behaviors by generating a distinct link associated with a record and embedded in a machine-readable code for every completed transaction. The records are associated with user devices when distinct links have been used. By this collection mechanism, user behavior can be accurately collected without pre-registered membership and domain boundary. The collected user behavior can be further analyzed to provide users with the information they need.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A personal service providing system, comprising:
a service end, being configured to generate a record of a transaction; and
an information collection and analysis server, being configured to receive the record from the service end via a network, store the record, generate a distinct link associated with the record, and transmit the distinct link to the service end via the network;
wherein the service end further generates a machine-readable code by embedding the distinct link therein so that when a user device obtains the distinct link from the machine-readable code, the user device transmits an identity to the information collection and analysis server through the distinct link via the network, and the information collection and analysis server further associates the identity with the record according to the distinct link.

2. The personal service providing system as claimed in claim 1, wherein the information collection and analysis server further stores other records associated with the identity, each of the other records is related to a transaction and associated with a distinct link, and the information collection and analysis server further analyzes the record and the other records to provide service information related to the transactions to the user device.

3. The personal service providing system as claimed in claim 1, wherein the information collection and analysis server further stores other records associated with the identity, each of the other records related to a transaction and associated with a distinct link, and the information collection and analysis server further analyzes the record and the other records to provide an analysis result to the service end.

4. The personal service providing system as claimed in claim 1, wherein the machine-readable code is a 2D barcode and the service end comprises:
a Point of Sales (POS) terminal, being connected to the network and configured to transmit the record to the information collection and analysis server, receive the distinct link from the information collection and analysis server, and generate the 2D barcode by embedding the distinct link therein; and
a receipt printer, being connected to the POS terminal and configured to print the 2D barcode on a receipt;
wherein the user device scans the 2D barcode to obtain the distinct link.

5. The personal service providing system as claimed in claim 1, wherein the information collection and analysis server further provides an add-on service when the user device accesses the information collection and analysis server through the distinct link.

6. A method for use in a personal service providing system including a service end and an information collection and analysis server, the method comprising:
(a) generating, by the service end, a record of a transaction;
(b) transmitting, by the service end, the record to the information collection and analysis server via a network;
(c) receiving, by the information collection and analysis server, the record from the service end via the network;
(d) storing, by the information collection and analysis server, the record;
(e) generating, by the information collection and analysis server, a distinct link associated with the record;
(f) transmitting, by the information collection and analysis server, the distinct link to the service end via the network;
(g) generating, by the service end, a machine-readable code by embedding the distinct link therein so that when a user device obtains the distinct link from the machine-readable code, the user device transmits an identity to the information collection and analysis server through the distinct link via the network; and
(h) associating, by the information collection and analysis server, the identity with the record according to the distinct link.

7. The method as claimed in claim 6, wherein the information collection and analysis server further stores other records associated with the identity, each of the other records related to a transaction and associated with a distinct link, and the method further comprises:
analyzing, by the information collection and analysis server, the record and the other records to provide service information related to the transactions to the user device.

8. The method as claimed in claim 6, the information collection and analysis server further stores other records associated with the identity, each of the other records related to a transaction and associated with a distinct link, and the method further comprises:
analyzing, by the information collection and analysis server, the record and the other records to provide an analysis result to the service end.

9. The method as claimed in claim 6, wherein the machine-readable code is a 2D barcode, the service end comprises a Point of Sales (POS) terminal and a receipt printer, and the method further comprising:
transmitting, by the POS terminal, the record to the information collection and analysis server via the network;
receiving, by the POS terminal, the distinct link from the information collection and analysis server via the network;
generating, by the POS terminal, the 2D barcode by embedding the distinct link therein; and
printing, by the receipt printer, the 2D barcode on a receipt;
wherein the user device scans the 2D barcode to obtain the distinct link.

10. The method as claimed in claim 6, further comprising:
providing, by the information collection and analysis server, an add-on service when the user device accesses the information collection and analysis server through the distinct link.

11. An information collection and analysis server, comprising:
a network interface, being connected to a network;
a processor, being electrically connected to the network interface and configured to receive a record of a transaction from a service end via the network interface, generate a distinct link associated with the record, and transmit the distinct link to the service end via the network interface, wherein the service end generates a machine-readable code by embedding the distinct link therein so that when a user device obtains the distinct link from the machine-readable code, the user device transmits an identity to the information collection and analysis server through the distinct link via the network, and the processor further receives the identity from the user device via the network interface and associates the identity with the record according to the distinct link; and
a storage, being electrically connected to the processor and configured to store the record, the distinct link and the identity.

12. The information collection and analysis server as claimed in claim 11, wherein the storage further stores other records associated with the identity, each of the other records related to a transaction and associated with a distinct link, and the processor further analyzes the record and the other records to generate service information related to the transactions and transmits the service information to the user device via the network interface.

13. The information collection and analysis server as claimed in claim 11, wherein the storage further stores other records associated with the identity, each of the other records related to a transaction and associated with a distinct link, and the processor further analyzes the record and the other records to generate an analysis result and transmits the analysis result to the service end via the network interface.

14. The information collection and analysis server as claimed in claim 11, wherein the machine-readable code is a 2D barcode and the user device scans the 2D barcode to obtain the distinct link.

15. The information collection and analysis server as claimed in claim 11, wherein the processor further generates add-on information when the user device accesses the information collection and analysis server through the distinct link, and transmits the add-on information to the user device via the network interface.

16. A method for use in an information collection and analysis server, the information collection and analysis server comprising a network interface, a processor and a storage, the network interface connected to a network, the method executed by the processor and comprising:
(a) receiving a record of a transaction from a service end via the network interface;
(b) storing the record in the storage;
(c) generating a distinct link associated with the record;
(d) transmitting the distinct link to the service end via the network interface, wherein the service end generates a machine-readable code by embedding the distinct link therein so that when a user device obtains the distinct link from the machine-readable code, the user device transmits an identity to the information collection and analysis server through the distinct link via the network;
(e) receiving the identity from the user device via the network interface; and
(f) associating the identity with the record according to the distinct link.

17. The method as claimed in claim 16, wherein the storage further stores other records associated with the identity, each of the other records related to a transaction and associated with a distinct link, and the method further comprising:
analyzing the record and the other records to generate service information related to the transactions; and
transmitting the service information to the user device via the network interface.

18. The method as claimed in claim 16, wherein the storage further stores other records associated with the identity, each of the other records related to a transaction and associated with a distinct link, and the method further comprising:
analyzing the record and the other records to generate an analysis result; and
transmitting the analysis result to the service end via the network interface.

19. The method as claimed in claim 16, wherein the machine-readable code is a 2D barcode and the user device scans the 2D barcode to read the distinct link.

20. The method as claimed in claim 16, further comprising:
generating add-on information when the user device accesses the information collection and analysis server through the distinct link; and
transmitting the add-on information to the user device via the network interface.
